(19) United States
(12) Patent Application Publication
(10) Pub. No.: US 2010/0026747 A1
(43) Pub. Date: Feb. 4, 2010

(54) PRINTING APPARATUS AND METHOD OF ADJUSTING NOZZLE ARRAY

(76) Inventors: Toru Miyamoto, Shiojiri-shi (JP); Toru Takahashi, Azumino-shi (JP); Hirokazu Kasahara, Okay-ashi (JP); Hideaki Kasahara, Matsumoto-shi (JP)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 12/533,865

(22) Filed: Jul. 31, 2009

(30) Foreign Application Priority Data
Jul. 31, 2008 (JP) 2008-198329

(51) Int. Cl. B41J 29/38; B41J 2/145

(52) U.S. Cl. 347/12; 347/40

(57) ABSTRACT

A printing apparatus includes: a first nozzle array with nozzles aligned in a predetermined direction for ejecting liquid on a medium; a second nozzle array with nozzles aligned in the predetermined direction for ejecting liquid on the medium, the second nozzle array being aligned in a direction cross to the predetermined direction of the first nozzle array; and a moving mechanism for relatively moving the first nozzle array, the second nozzle array, and the medium in the moving direction. Here, when a plurality of dot arrays disposed along the moving direction is formed in a direction cross to the moving direction with a predetermined interval therebetween by using the nozzles belonging to the first nozzle array, and a plurality of dot arrays disposed along the moving direction is formed in a direction cross to the moving direction with a predetermined interval therebetween by using the nozzles belonging to the second nozzle array, the dot arrays are formed by a specific first nozzle among the nozzles belonging to the first nozzle array and a specific second nozzle among the nozzles belonging to the second nozzle array, and have a length different from the dot arrays formed by the other nozzles.

### BACKGROUND

1. Technical Field

The present invention relates to a printing apparatus and a method of adjusting a nozzle array.

2. Related Art

There has been known a printing apparatus that includes nozzles for ejecting liquid on a medium and nozzle arrays including the nozzles aligned in a predetermined direction. The printing apparatus performs a printing process by relatively moving the nozzle arrays and the medium in a moving direction cross to the predetermined direction. In such a printing apparatus, in a case where the nozzle arrays are inclined in the predetermined direction or the nozzle arrays are shifted in the predetermined direction, dots are not formed in a position indicated by print data, so that images are degraded.

There is proposed a method in which by using two nozzle arrays (a first nozzle array and a second nozzle array) which are aligned in the moving direction cross to a nozzle array direction, a corrective pattern is formed, and then on the basis of the result of the corrective pattern, a slope of the nozzle array is detected (for example, refer to JP-A-2005-96368). Specifically, the first nozzle array and the second nozzle array alternatively form the corrective patterns which include dot arrays disposed along the moving direction in order for the corrective patterns to be aligned in the nozzle array direction. On the basis of an interval between a first corrective pattern formed by the first nozzle array and a second corrective pattern formed by the second nozzle array in the nozzle array direction, the slope of the nozzle array and misalignment of plural nozzle arrays in the nozzle array direction are detected.

However, in the above-mentioned detection method, when the slope of the nozzle array or the misalignment in the nozzle array direction increases, the first corrective pattern and the second corrective pattern which are originally adjacent to each other in the nozzle array direction are formed not adjacent, but separated away from each other. If so, on the basis of the interval between the first corrective pattern and the second corrective pattern which are originally not adjacent to each other in the nozzle array direction, the slope of an erroneous nozzle array or the misalignment in an erroneous nozzle array direction is rather detected.

The invention has been made in order to solve the above-mentioned problem, and an object is to accurately detect the slope of the nozzle array and the misalignment of the nozzle array direction of the plural nozzle arrays.

### SUMMARY

According to an aspect of the invention, there is provided a printing apparatus including: a first nozzle array with nozzles aligned in a predetermined direction for ejecting liquid on a medium; a second nozzle array with nozzles aligned in the predetermined direction for ejecting liquid on the medium, the second nozzle array being aligned in a direction cross to the predetermined direction of the first nozzle array; and a moving mechanism for relatively moving the first nozzle array, the second nozzle array, and the medium in the moving direction. Here, when a plurality of dot arrays disposed along the moving direction is formed in a direction cross to the moving direction with a predetermined interval therebetween by using the nozzles belonging to the first nozzle array, and a plurality of dot arrays disposed along the moving direction is formed in a direction cross to the moving direction with a predetermined interval therebetween by using the nozzles belonging to the second nozzle array, the dot arrays are formed by a specific first nozzle among the nozzles belonging to the first nozzle array and a specific second nozzle among the nozzles belonging to the second nozzle array, and have a length different from the dot arrays formed by the other nozzles.

Other aspects of the invention will be apparent through the descriptions of this specification and the accompanying drawings.

### BRIEF DESCRIPTION OF THE DRAWINGS

The invention will be described with reference to the accompanying drawings, wherein like numbers reference like elements.

FIG. 1 is a block diagram illustrating an entire configuration of a printer according to an embodiment.

FIG. 2A is a sectional view illustrating a printer.

FIG. 2B is a view illustrating a printer transporting a paper.

FIG. 3A is a view illustrating an alignment of heads.

FIG. 3B is a view illustrating an alignment of nozzles.

FIG. 4A is a view illustrating dot formation of a head not inclining.

FIG. 4B is a view illustrating dot formation of a head inclining.

FIG. 5 is a flowchart illustrating a process of detecting a slope of a head.

FIG. 6A is an overall view illustrating a test pattern.

FIG. 6B is an enlarged view illustrating a first pattern.

FIG. 6C is an enlarged view illustrating a second pattern.

FIG. 7A is a view illustrating a first pattern formed by a head not inclining.

FIG. 7B is a view illustrating a first pattern formed by a head inclining.

FIG. 7C is a view illustrating a first pattern formed by a head inclining.

FIG. 8A is a view illustrating a first pattern P1 formed by two black nozzle arrays K1 and K2 of which an interval therebetween in a direction cross to a nozzle array direction is short.

FIG. 8B is a view illustrating a first pattern P1 formed by a black nozzle array K2 and a yellow nozzle array Y1 of which an interval therebetween in a direction cross to a nozzle array direction is long.

FIG. 9 is a view illustrating a first pattern P1 formed when a slope of a head 31 is large.

FIG. 10A is a view illustrating a first pattern formed with two heads not inclining.

FIG. 10B is a view illustrating a test pattern formed with two heads 31 inclining according to a comparative example.

FIG. 11A is a view illustrating adjustment for a positional relationship between plural heads.

FIG. 11B is a view illustrating adjustment for a positional relationship between plural heads.

FIG. 12A is a view illustrating a test pattern according to a modified example.

FIG. 12B is a view illustrating a test pattern according to a modified example.

FIG. 13A is a view illustrating a test pattern according to a modified example.

FIG. 13B is a view illustrating a test pattern according to a modified example.

FIG. 13C is a view illustrating a test pattern according to a modified example.

FIG. 14A is a view illustrating an alignment of heads.

FIG. 14B is a view illustrating an alignment of nozzles.

FIG. 15A is a view illustrating dots formed by two heads which are not shifted in a paper width direction.

FIG. 15B is a view illustrating dots formed by two heads which are shifted in a paper width direction.

FIG. 16A is a view illustrating dots formed by two heads which are not shifted in a paper width direction.

FIG. 16B is a view illustrating dots formed by two heads which are shifted in a paper width direction.

FIG. 16C is a view illustrating dots formed by two heads which are shifted in a paper width direction.

FIG. 17 is a view illustrating a first pattern which is formed in a case of a large amount of misalignment.

### DESCRIPTION OF EXEMPLARY EMBODIMENTS

### Outlines of Disclosure

At least the following aspects will be apparent through the descriptions of this specification and the accompanying drawings.

That is, a printing apparatus includes: a first nozzle array with nozzles aligned in a predetermined direction for ejecting liquid on a medium; a second nozzle array with nozzles aligned in the predetermined direction for ejecting liquid on the medium, the second nozzle array being aligned in a direction cross to the predetermined direction of the first nozzle array; and a moving mechanism for relatively moving the first nozzle array, the second nozzle array, and the medium in the moving direction. Here, when a plurality of dot arrays disposed along the moving direction is formed in a direction cross to the moving direction with a predetermined interval therebetween by using the nozzles belonging to the first nozzle array, and a plurality of dot arrays disposed along the moving direction is formed in a direction cross to the moving direction with a predetermined interval therebetween by using the nozzles belonging to the second nozzle array, the dot arrays having a length different from the dot arrays formed by the other nozzles are formed by a specific first nozzle among the nozzles belonging to the first nozzle array and a specific second nozzle among the nozzles belonging to the second nozzle array.

According to such a print apparatus, the slope of the first nozzle array and the second nozzle array with respect to the predetermined direction and the misalignment between the first nozzle array and the second nozzle array in the predetermined direction can be detected on the basis of the interval between the dot arrays formed by the first nozzle array and the dot arrays formed by the second nozzle array in the predetermined direction. In addition, it is possible to determine that the dot arrays formed by the first nozzle array and the dot arrays formed by the second nozzle array, which are originally formed adjacent to each other, are separated away from each other when the nozzle array are inclined too much or shifted too much, on the basis of the positional relationship between the dot arrays formed by the specific first nozzle and the dot arrays formed by the specific second nozzle. As a result, the slope and the misalignment of the nozzle array can be detected with high accuracy, and thereby suppressing the image degradation.

In the print apparatus, the first nozzle is a nozzle closest to the second nozzle in the predetermined direction among the nozzles belonging to the first nozzle array.

According to such a print apparatus, it is possible to detect that the nozzle array is inclined too much or shifted according to whether or not the dot arrays formed by the first nozzle and the dot arrays formed by the second nozzle are formed adjacent to each other. As a result, the slope and the misalignment of the nozzle array can be detected with high accuracy.

In the print apparatus, two heads including the first nozzle array and the second nozzle array are aligned in the predetermined direction. Here, the first nozzle in one of the heads is a nozzle disposed close to an end portion of the other head among the nozzles belonging to the first nozzle array. In addition, the second nozzle in one of the heads is a nozzle disposed close to an end portion of the other head among the nozzles belonging to the second nozzle array.

According to such a print apparatus, it becomes easy to fine out the dot arrays formed in the joint portion between the heads. Further, on the basis of the interval between the dot arrays formed by the first nozzle array and the second nozzle array in one head, it is possible to prevent the slope and the misalignment of the nozzle array in the other head from detecting.

In the print apparatus, when the plurality of dot arrays is formed in a direction cross to the moving direction with the predetermined interval therebetween, another plurality of dot arrays disposed along the moving direction is formed in a direction cross to the moving direction with an interval wider than the predetermined interval therebetween by using the nozzles belonging to the first nozzle array, and another plurality of dot arrays another plurality of dot arrays disposed is formed in a direction cross to the moving direction with an interval wider than the predetermined interval therebetween by using the nozzles belonging to the second nozzle array.

According to such a print apparatus, when the dot arrays are formed on the medium capable of adsorbing the liquid very well, even though the dot arrays are formed at the predetermined interval, the interval between the dot arrays cannot be calculated due to the adsorption. When the dot arrays are formed at an interval wider than the predetermined interval, the interval between the dot arrays can be calculated. That is, regardless of the kind of the medium, the slope or the misalignment of the nozzle array can be detected.

In addition, a method of adjusting a nozzle array using a printing apparatus including a first nozzle array with nozzles aligned in a predetermined direction for ejecting liquid on a medium, a second nozzle array with nozzles aligned in the predetermined direction for ejecting liquid on the medium, the second nozzle array being aligned in a direction cross to the predetermined direction of the first nozzle array, and a moving mechanism for relatively moving the first nozzle array, the second nozzle array, and the medium in the moving direction, the method includes: when a plurality of dot arrays disposed along the moving direction is formed in a direction cross to the moving direction with a predetermined interval therebetween by using the nozzles belonging to the first nozzle array, and a plurality of dot arrays disposed along the moving direction is formed in a direction cross to the moving direction with a predetermined interval therebetween by using the nozzles belonging to the second nozzle array, forming the dot arrays by a specific first nozzle among the nozzles belonging to the first nozzle array and a specific second nozzle among the nozzles belonging to the second nozzle array, the dot arrays having a length different from the dot arrays formed by the other nozzles; and adjusting mounting positions of the first nozzle array and the second nozzle array in the print apparatus on the basis of a positional relationship between the dot arrays formed by the first nozzle array and the dot arrays formed by the second nozzle array in a direction cross to the moving direction.

According to such a method of adjusting the nozzle array, on the basis of the positional relationship between the dot arrays formed by the specific first nozzle and the dot arrays formed by the specific second nozzle, it is possible to determine that the dot arrays formed by the first nozzle array and the dot arrays formed by the second nozzle array, which are originally formed adjacent to each other, are separated away from each other when the nozzle array are inclined too much or shifted too much. As a result, the slope and the misalignment of the nozzle array can be detected with high accuracy.

In the method of adjusting the nozzle array, a positional relationship between the first nozzle array and the second nozzle array in a direction cross to the moving direction is adjusted.

According to such a method of adjusting the nozzle array, it is possible to suppress the image degradation.

In the method of adjusting the nozzle array, the slopes of the first nozzle array and the second nozzle array with respect to a direction cross to the moving direction are adjusted.

According to such a method of adjusting the nozzle array, it is possible to suppress the image degradation.

In the method of adjusting the nozzle array, the print apparatus includes another nozzle array between the first nozzle array and the second nozzle array, the another nozzle array including nozzles which eject the liquid on the medium and are aligned in the predetermined direction.

According to such a method of adjusting the nozzle array, even though the slopes of the nozzle arrays are all the same, as the first nozzle array and the second nozzle array are separated to a direction cross to the predetermined direction, the positional misalignment between the dot arrays formed by the first nozzle array and the dot arrays formed by the second nozzle array becomes large. For this reason, also a small slope can be detected, and the slope of the nozzle array can be detected with high accuracy.

### Line Head Printer

Hereinafter, it is assumed that a printing apparatus is an ink jet printer, and a line head printer (printer 1) among the ink jet printer will be described as an example.

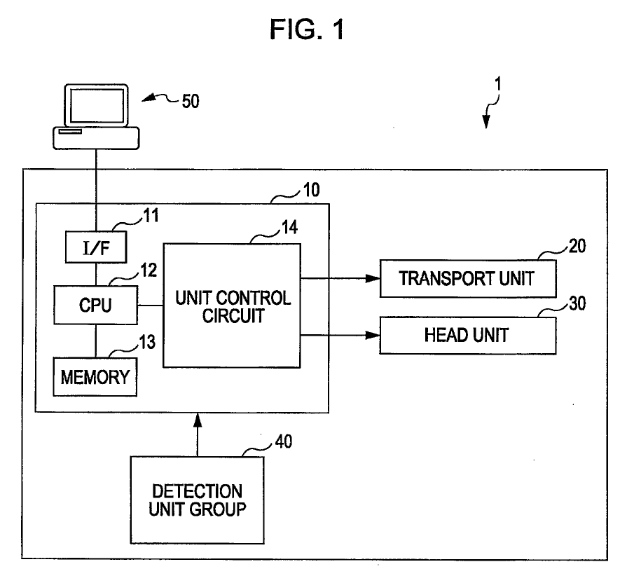

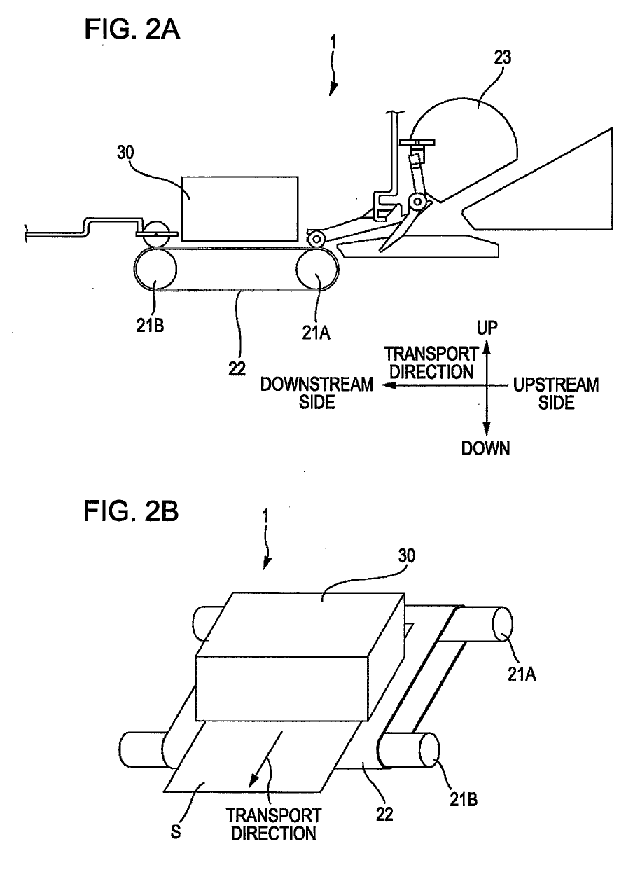

FIG. 1 is a block diagram illustrating an entire configuration of the printer 1 according to this embodiment. FIG. 2A is a sectional view illustrating the printer 1. FIG. 2B is a view illustrating the printer 1 transporting a paper S (medium). The printer 1 receives print data from a computer 50 as an external apparatus, and controls units (transport unit 20, head unit 30) by a controller 10 to form an image on the paper S. In addition, a detector group 40 monitors circumstances in the printer 1, and the controller 10 controls the respective units on the basis of the detection results.

The controller 10 is a control unit for performing control on the printer 1. An interface unit 11 serves to transmit and receive data between the computer 50 as the external apparatus and the printer 1. A CPU 12 is an arithmetic processing unit for performing control on the entire printer 1. A memory 13 serves to secure areas for storing programs executed by the CPU 12 or working areas. The CPU 12 controls the respective units by a unit controlling circuit 14 according to the programs stored in the memory 13.

The transport unit 20 includes transport rollers 21A and 21B and a transport belt 22. The transport unit 20 feeds the paper S to a printable position. In printing, the transport unit 20 transports the paper S inserted into the paper insertion port in a transport direction (corresponding to a moving direction) at a predetermined transport speed. A feed roller 23 is a roller for automatically feeding the paper S onto the transport belt 22 in the printer 1. As the annular transport belt 22 is rotated by the transport rollers 21A and 21B, the paper S is transported onto the transport belt 22. In addition, the transport belt 22 vacuum-adsorbs the paper thereon to prevent the paper from a positional misalignment.

The head unit 30 serves to eject the ink onto the paper S, and includes plural heads 31. On the bottom surface of the head 31, plural nozzles are provided to serve as an ink ejecting portion. In connection with each nozzle, there are provided a pressure chamber (not shown) filled with the ink and a driving element (piezoelectric element) for changing capacity in the pressure chamber to eject the ink. When a driving signal is applied to the driving element, the driving element is deformed. Then, according to the deformation, the pressure chamber expands and shrinks to eject the ink.

In such a line head printer, when the controller 10 receives the print data, the controller 10 first rotates the feed roller 23 to transport the printing paper S onto the transport belt 22. The paper S is transported on the transport belt 22 at a constant speed without stopping, and then passes through under the head unit 30. During the paper S passes through under the head unit 30, the respective nozzles intermittently eject the ink. As a result, the dot arrays made of plural dots disposed along the transport direction are formed on the paper S, and thus the image is printed.

### First Embodiment

### Nozzle Alignment

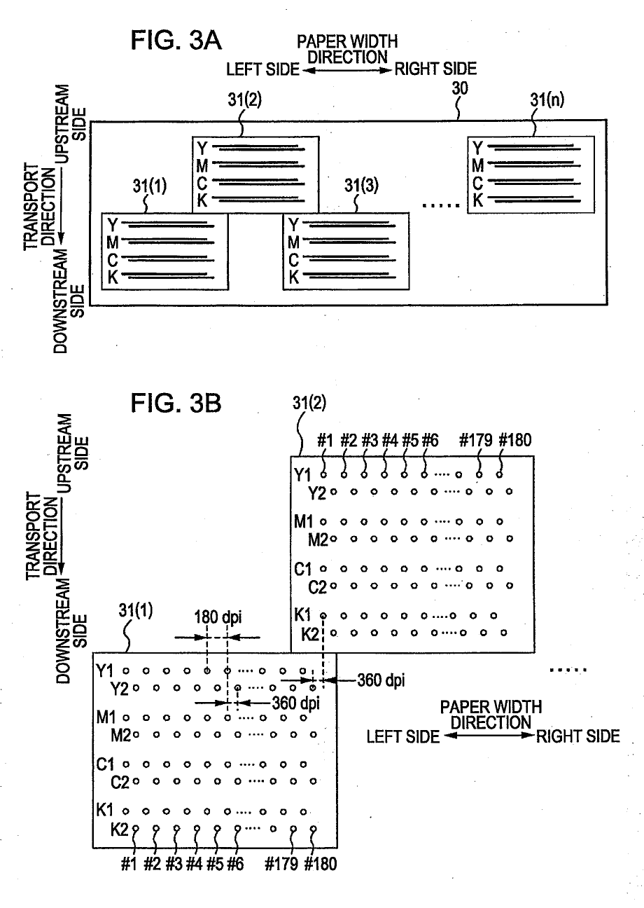

FIG. 3A is a view illustrating an alignment of the heads 31 formed on the bottom surface of the head unit 30 according to a first embodiment. FIG. 3B is a view illustrating an alignment of the nozzles formed on the bottom surface of the heads 31. In the printer 1 according to the first embodiment, the head unit 30 includes plural (“n” pieces) heads 31, and the plural heads 31(1) to 31(n) are disposed in a staggered shape in a paper width direction (corresponding to a direction cross to the moving direction) cross to the transport direction. As shown in FIG. 3B, each head 31 includes two nozzle arrays per one color. On the bottom surface of each head 31, two yellow nozzle arrays Y1 and Y2, two magenta nozzle arrays M1 and M2, two cyan nozzle arrays C1 and C2, and two black nozzle arrays K1 and K2 are formed.

Each nozzle array is provided with “180” nozzles (nozzle #1 to nozzle #180), the nozzles in each nozzle array are arranged in the paper width direction with a predetermined interval of 180 dpi therebetween. Two nozzle arrays (for example, Y1 and Y2) ejecting the same color of ink are shifted by 360 dpi in the paper width direction. That is, in one head 31, the nozzles ejecting four colors of ink Y, M, C, and K are aligned in the paper width direction with the interval of 360 dpi therebetween. Among two heads (for example, 31(1) and 31(2)) aligned in the paper width direction, also the interval between the rightmost nozzle #180 in a left head (for example, 31(1)) and the leftmost nozzle #1 in a right head (for example, 31(2)) in the paper width direction is set to be 360 dpi. In this way, the heads 31(1) to 31(n) are disposed.

That is, on the bottom surface of the head unit 30, the nozzles ejecting four colors of ink Y, M, C, and K are aligned in the paper width direction with the interval of 360 dpi (nozzle pitch) therebetween. A length obtained by summing the nozzle arrays in each head 31 corresponds to a maximum print range in the paper width direction of the printer 1. Further, in FIG. 3B, the nozzle arrays in the heads 31 disposed adjacent to each other in the paper width direction are not overlapped with each other, but the invention is not limited thereto. The end portions of the nozzle arrays in the heads 31 disposed adjacent to each other may be overlapped.

### Slope of Head 31

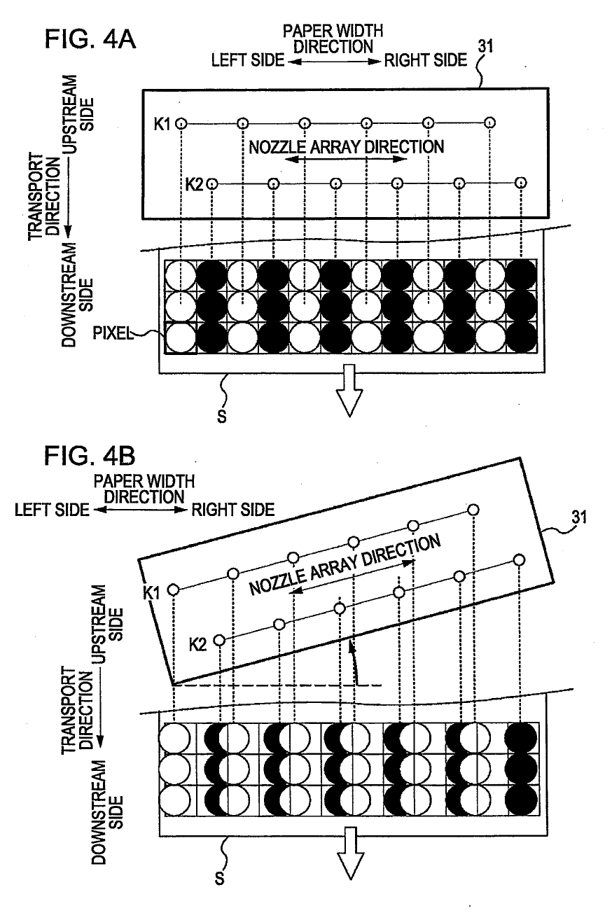

FIG. 4A is a view illustrating a dot formation of the printer 1 in which the head 31 is not inclined, but mounted in parallel to the paper width direction. FIG. 4B is a view illustrating a dot formation of the printer 1 in which the head 31 is obliquely mounted with respect to the paper width direction. In the drawings, the heads 31 are illustrated by reducing the number of the nozzles of two black nozzle arrays K1 and K2, for convenience of explanation. The nozzle arrays provided on the bottom surface of the head 31 are configured to include plural nozzles which are aligned in a predetermined direction (hereinafter, referred to as a nozzle array direction). The head 31 is mounted such that the nozzle array direction is parallel to the paper width direction cross to the transport direction which is defined on the basis of the transport unit 20 of the printer 1.

In addition, on the paper S, a virtual “pixel” is given in order to define positions of the dots to be recorded. A print image is configured such that the pixels are two-dimensionally aligned in parallel to the side directions (vertical direction and horizontal direction) of the paper S. The paper S is transported such that the vertical side of the paper S is parallel to the transport direction in the printer 1. That is, on the paper S, the pixels are aligned in the transport direction and the paper width direction cross to the transport direction. In the drawing, the pixels are aligned in the paper width direction with the nozzle pitch interval (360 dpi) therebetween, and the paper S is transported such that the pixels aligned in the paper width direction face the nozzles.

As shown in FIG. 4A, when the nozzle arrays are disposed along the paper width direction, the dot arrays aligned in the transport direction with the interval of 360 dpi therebetween are formed by two black nozzle arrays K1 and K2. That is, when the head 31 (nozzle array) is mounted in parallel to the paper width direction, the dots (o) formed by the upstream black nozzle array K1 in the transport direction and the dots (•) formed by the downstream black nozzle array K2 in the transport direction are aligned at equal intervals (360 dpi) in the paper width direction.

As shown in FIG. 4B, when the head 31 (nozzle array) is obliquely mounted with respect to the paper width direction, the dots are formed on positions shifted from the pixels defined on the paper S. In addition, since two black nozzle arrays K1 and K2 are disposed separate in a direction cross to the nozzle array direction, misalignment amounts of the dot forming positions are different from each other. In FIG. 4B, the dots (o) formed by the upstream black nozzle array K1 in the transport direction and the dots (•) formed by the downstream black nozzle array K2 in the transport direction are formed to be overlapped with each other. That is, when the head 31 (nozzle array) is obliquely mounted with respect to the paper width direction, the intervals between the dots aligned in the paper width direction do not become constant.

In this way, when the head 31 (nozzle array) is obliquely mounted with respect to the paper width direction, the dots are not formed on the positions (pixel) indicated by the print data. Further, the intervals between the dots aligned in the paper width direction do not become constant. Therefore, the print image quality is degraded. An object in the first embodiment is to detect the slope of the head 31 with respect to the paper width direction and to adjust the slope of the head 31. By this, it is possible to suppress the degradation of the print image quality.

### Slope Adjustment of Head 31

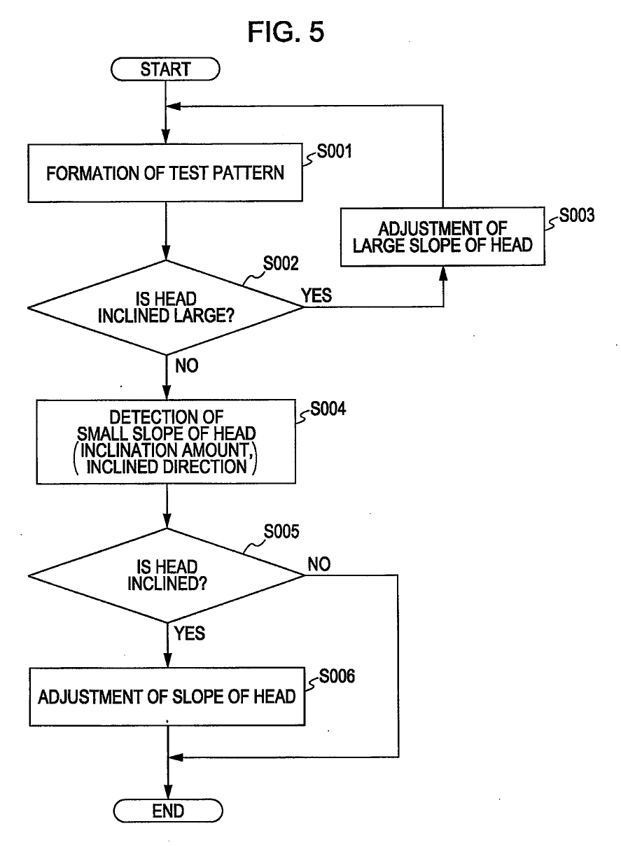

FIG. 5 is a flowchart illustrating a process of detecting and adjusting a slope of the head 31. Hereinafter, a case where plural heads 31 are mounted on the printer 1 during a manufacturing process and then the slope of each head 31 with respect to the paper width direction is detected will be described as an example. In the first embodiment, the plural heads 31 are mounted on the printer 1, and then the printer 1 is caused to actually print test patterns (S001) to detect the slopes of the heads 31 on the basis of the result of the test patterns.

### Test Pattern

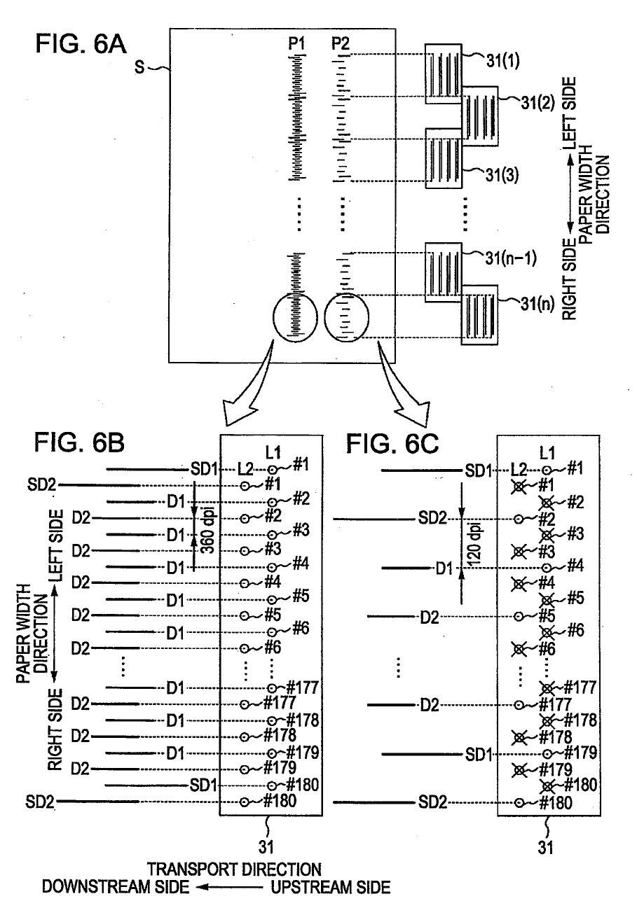

FIG. 6A is an overall view illustrating the test pattern printed on the paper S. FIG. 6B is an enlarged view illustrating a first pattern P1. FIG. 6C is an enlarged view illustrating a second pattern P2. In the drawings, the nozzles belonging to nozzle arrays L1 and L2 in the heads 31 are sequentially assigned with a lower number from the left nozzle in the paper width direction. The first pattern P1 and the second pattern P2 are formed by one head 31. For this reason, on the paper S, the first pattern P1 and the second pattern P2 are aligned in the paper width direction. In addition, the first pattern P1 and the second pattern P2 are formed of two nozzle arrays (the first nozzle array L1 and the second nozzle array L2) among eight nozzle arrays included in the head 31. The first nozzle array L1 and the second nozzle array L2 which are shifted to each other in the paper width direction are selected. In the following descriptions, the “first nozzle array L1” is assumed as a “yellow nozzle array Y1” shown in FIG. 3, and the “second nozzle array L2” is assumed as a “black nozzle array K2”.

First, the first pattern P1 will be described (see FIG. 6B). The first pattern P1 is configured of the dot arrays disposed along the transport direction (moving direction). The dot array formed by each nozzle in the first nozzle array L1 is called as a “first dot array D1”, and the first dot arrays D1 are formed at an interval (a predetermined interval) of 180 dpi. On the other hand, the dot arrays formed by each nozzle in the second nozzle array L2 are called as a “second dot array D2”, and the second dot arrays D2 are also formed at the interval of 180 dpi. The first pattern P1 is formed by all of the nozzles (#1 to #180) belonging to the first nozzle array L1 and all of the nozzles (#1 to #180) belonging to the second nozzle array L2. For this reason, the first dot arrays D1 and the second dot arrays D2 are alternatively aligned in the paper width direction with the interval of 360 dpi therebetween. In other words, the second dot array D2 is formed in the center portion of the first dot arrays D1 aligned in the paper width direction.

The downstream portion of the first dot array D1 in the transport direction and the upstream portion of the second dot array D2 in the transport direction are formed to be overlapped with each other. The first dot array D1 has the same length as that of the second dot array D2. The first dot array D1 is formed on the upstream side from the second dot array D2 in the transport direction, and on the contrary the second dot array D2 is formed on the downstream side from the first dot array D1 in the transport direction. In this way, the first dot array D1 and the second dot array D2 are formed on positions shifted in the transport direction. Therefore, when the dot arrays constituting the first pattern P1 are viewed, it can be determined whether or not the dot arrays are the dot arrays D1 formed by the first nozzle array L1 or the dot arrays D2 formed by the second nozzle array L2.

In addition, the dot arrays SD1 formed by the nozzles #1 and #180 (a specific first nozzle) disposed in the end portions of the first nozzle array L1 are formed longer than the dot arrays D1 formed by the other nozzles #2 to #179 on the upstream side in the transport direction. In the same way, the dot arrays formed by the nozzles #1 and #180 (a specific second nozzle) disposed in the end portions of the second nozzle array L2 are formed longer than the dot arrays formed by the other nozzles #2 to #179 on the downstream side in the transport direction. The long dot arrays formed by the nozzles disposed in the end portions of the first nozzle array are called “first reference dot arrays SD1”, and the long dot arrays formed by the nozzles disposed in the end portions of the second nozzle array are called “second reference dot arrays SD2”. In this embodiment, the length of the dot array formed by the specific nozzle in the first nozzle array L1 or the second nozzle array L2 is formed differently in length from that of the dot arrays formed by the other nozzle arrays. Then, the second nozzle array forms the dot array (the second reference dot array) which is different in length from that of the dot arrays formed by the other nozzles. The nozzle (nozzle disposed in the end portion) in the first nozzle array is selected which has the shortest distance from the nozzle (nozzle disposed in the end portion) of the second nozzle array in the nozzle array direction. The dot array (the first reference dot array) which is different in length from that of the dot arrays formed by the other nozzles is formed.

Next, the second pattern P2 will be described (see FIG. 6C). The second pattern P2 is formed by using the nozzles fewer than that in the case of the first pattern P1. The first dot array D1 is formed by using every third nozzle (#1, #4, #7, . . . ) belonging to the first nozzle array L1, and the second dot array D2 is formed by using every third nozzle (#2, #5, #8, . . . ) belonging to the second nozzle array L2. For this reason, the second pattern P2 is formed at an interval (120 dpi) between the first dot array D1 and the second dot array D2 in the paper width direction which is wider than the first pattern. The configurations other than the interval between the dot arrays are similar to the first pattern P1. The first dot array D1 is formed in a position shifted from the second dot array D2 to the upstream side in the transport direction. Then, the nozzles #1 and #179 disposed in the end portions of the first nozzle array L1 and the nozzles #2 and #180 disposed in the end portions of the second nozzle array L2 form the dot arrays SD1 and SD2 longer than those formed by the other nozzles.

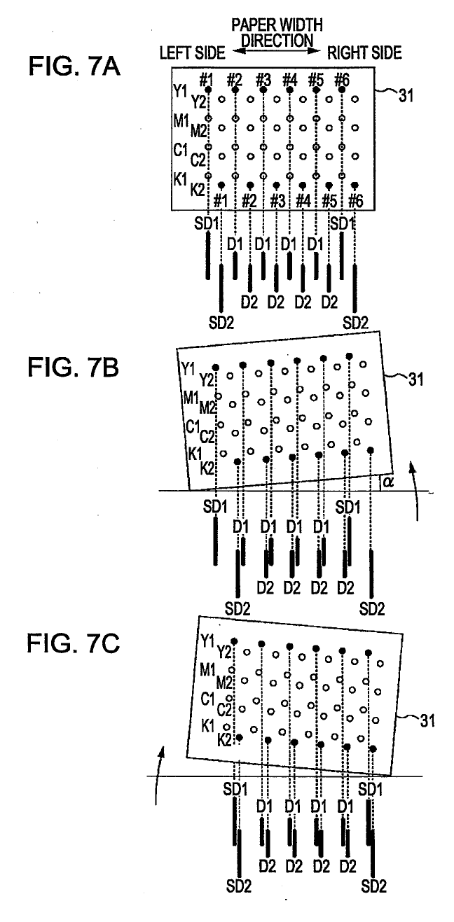

FIG. 7A is a view illustrating the first pattern P1 formed in a case where the head 31 (nozzle array) is formed in parallel to the paper width direction. FIG. 7B is a view illustrating the first pattern P1 formed in a case where the head 31 is obliquely formed in a counterclockwise direction to the paper width direction. FIG. 7C is a view illustrating the first pattern P1 formed in a case where the head 31 is obliquely formed in a clockwise direction to the paper width direction. For convenience of explanation, the heads 31 are illustrated by reducing the number of the nozzles.

As shown in FIG. 7A, when the nozzle arrays are formed in parallel to the paper width direction as they were designed, the interval between the first dot arrays D1 and the second dot arrays D2 in the first pattern P1 to be formed is similar to the interval of “360 dpi” between the nozzles of the first nozzle array L1 and the nozzles of the second nozzle array L2. That is, the second dot array D2 is formed in the center portion between two first dot arrays D1 aligned in the paper width direction.

On the other hand, as shown in FIG. 7B, when the nozzle arrays are inclined in the counterclockwise direction to the paper width direction, the second dot array D2 is formed close to the first dot array D1 disposed on the right side thereof among two first dot arrays D1 aligned in the paper width direction. On the contrary, as shown in FIG. 7C, when the nozzle arrays are inclined in the clockwise direction to the paper width direction, the second dot array D2 is formed close to the first dot array D1 disposed on the left side thereof among two first dot arrays D1 aligned in the paper width direction.

In this way, when the head 31 (nozzle array) are obliquely mounted with respect to the paper width direction, the interval between the first dot array D1 and the second dot array D2 in the paper width direction does not become constant. That is, the second dot array D2 is not formed in the center portion between two first dot arrays D1 aligned in the paper width direction, but the second dot array D2 is formed close to the right side or the left side.

Referring to the printed result of the first pattern P1, it is possible to determine whether or not the head 31 is inclined with respect to the paper width direction according to whether or not the second dot array D2 is formed in the center portion between the first dot arrays D1 aligned in the paper width direction. Similarly, it is possible to detect the slope of the head 31 according to whether or not the first dot array D1 is formed in the center portion between the second dot arrays D2 aligned in the paper width direction.

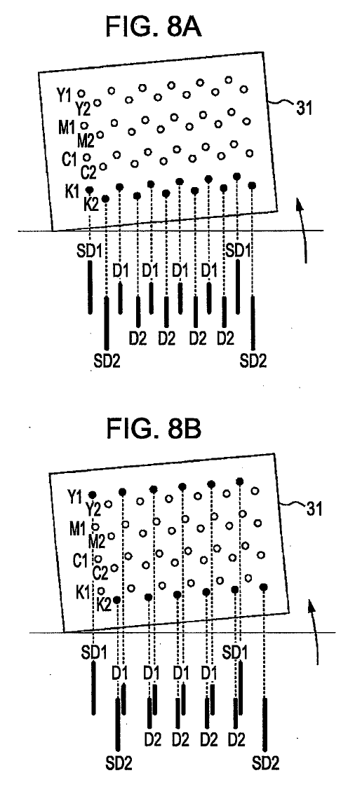

FIG. 8A is a view illustrating the first pattern P1 formed by two black nozzle arrays K1 and K2 of which the interval therebetween in a direction cross to the nozzle array direction is short. FIG. 8B is a view illustrating the first pattern P1 formed by the black nozzle array K2 and the yellow nozzle array Y1 of which the interval therebetween in a direction cross to the nozzle array direction is long. In the first embodiment, referring to the result of the test pattern, it is possible to detect the slope of the head 31 on the basis of the positional relationship between the first dot arrays D1 formed by the first nozzle array L1 and the second dot arrays D2 formed by the second nozzle array. In other words, misalignment amounts between the dot positions formed when the nozzle array is parallel to the paper width direction and the dot positions formed when the nozzle array is inclined with respect to the paper width direction are different between the first nozzle array L1 and the second nozzle array L2, so that the slope of the head 31 is detected by using the difference.

The inclination amounts of the head 31 in the FIGS. 8A and 8B are similar. However, the misalignment amount of the second dot array D2 formed between two first dot arrays D1 shown in FIG. 8B is larger than that shown in FIG. 8A. That is, the test patterns P1 and P2 are formed by two nozzle arrays which are separated away from each other in a direction cross to the nozzle array direction (other nozzles are disposed between the first nozzle array L1 and the second nozzle array L2). By this, the misalignment amount in the positional relationship between the first dot array D1 and the second dot array D2 becomes large even when the slope of the head 31 is small. Therefore, it is possible to detect the slope of the head 31 with high accuracy. For this reason, two nozzle arrays separated in a direction cross to the nozzle array direction are selected as the first nozzle array L1 and the second nozzle array L2, and then the test pattern may be formed.

In addition, in the first embodiment, the yellow nozzle array Y1 is selected as the first nozzle array L1, the black nozzle array K2 separated farthest from the yellow nozzle array Y1 is selected as the second nozzle array L2, and then the test patterns P1 and P2 are formed. In this case, since the dot arrays formed by the yellow nozzle arrays are difficult to be visually identified, the magenta nozzle array M1 which is disposed next to the yellow nozzle array Y1 and separated from the black nozzle array K2 is selected as the first nozzle array, and the test pattern may be formed.

### Large Slope Detection of Head 31

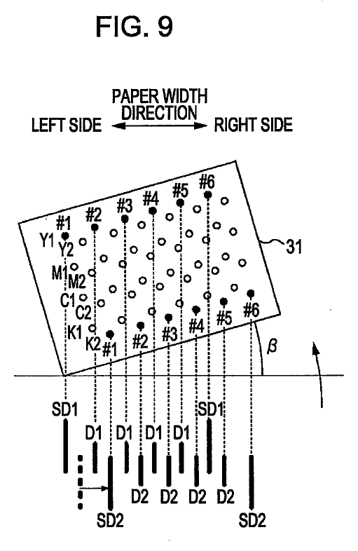

FIG. 9 is a view illustrating the first pattern P1 formed in a case where the slope of the head 31 is large. Also in FIG. 9 as similar to FIG. 7B, the head 31 (nozzle array) is inclined in the counterclockwise direction to the paper width direction. In this case, the slope (angle β) of the head 31 shown in FIG. 9 is larger than the slope (angle α) of the head 31 shown in FIG. 7B. When the head 31 is inclined in the counterclockwise direction, the second dot array D2 formed between two first dot arrays D1 aligned in the paper width direction is formed close to the first dot array D1 disposed on the right side thereof. However, as shown in FIG. 9, when the slope of the head 31 is excessively large, the second dot array D2 is rather formed in a right position separated away from the first dot array D1 disposed on the right side thereof. That is, when the head 31 is formed in parallel to the paper width direction, the first dot array D1 and the second dot array D2 are formed adjacent to each other. However, when the slope of the head 31 is excessively large, the first dot array D1 and the second dot array D2 are not adjacent to each other in the paper width direction, but formed in a state of being separated away from each other.

For example, as shown in FIG. 7A, when the head 31 is not inclined, the second dot array D2 formed by the nozzle #3 of the black nozzle array K2 is positioned between the first dot arrays D1 which is formed by the nozzle #3 and the nozzle #4 of the yellow nozzle array Y1. However, as shown in FIG. 9, when the head 31 is inclined too much, the second dot array D2 formed by the nozzle #2 of the black nozzle array K2 is positioned between the first dot arrays D1 which are formed by the nozzle array #3 and the nozzle array #4 of the yellow nozzle array Y1.

In the first embodiment, as described above, the slope of the head 31 is detected on the basis of the position of the second dot array D2 which is formed between two first dot arrays D1 adjacent to each other in the paper width direction. For this reason, when the head 31 is excessively inclined, there is some fear that an erroneous slope of the head 31 is detected on the basis of the positional relationship between the first dot arrays D1 adjacent to each other in the paper width direction and the second dot array D2 different from one to be originally formed between the first dot arrays.

For example, as shown in FIG. 9, since the slope of the head 31 is large and the second dot array D2 is formed in a position shifted to the right side, the second dot array D2 (for example, the second dot array D2 formed by the nozzle #2 of the black nozzle array K2) different from the second dot array D2 to be originally formed is positioned in the center portion between two first dot arrays D1 (for example, the first dot arrays formed by the nozzles #3 and #4 of the yellow nozzle array Y1) aligned in the paper width direction. Therefore, there is some fear that the head 31 is determined not to be inclined. As a result, the slope of the head 31 cannot be detected accurately, and it is impossible to suppress the degradation of the print image quality.

In the first embodiment, as the slope adjustment flow (method of adjusting the nozzle array) of the head 31 shown in FIG. 5, the test pattern is formed (S001), and then it is determined whether or not the head 31 is inclined too much (S002). For this purpose, the large slope of the head 31 is detected according to whether or not the reference first dot array SD1 and the reference second dot array SD2 which are different from the other dot arrays in length are formed adjacent to each other in the paper width direction. The reference first dot array SD1 is formed by the nozzle #1 (or the nozzle #180) disposed in the end portion of the first nozzle array L1. On the other hand, the reference second dot array SD2 is formed by the nozzle #1 disposed in the end portion of the second nozzle array L2 which is disposed closest to the nozzle #1 disposed in the end portion of the first nozzle array L1 in the paper width direction. For this reason, when the head 31 is not inclined too much, the reference first dot array SD1 and the reference second dot array SD2 are formed adjacent to each other.

Further, in this embodiment, the first nozzle array L1 is shifted from the second nozzle array L2 on the left side thereof in the paper width direction. For this reason, when the reference second dot array SD2 is formed between the reference first dot array SD1 formed by the nozzle #1 disposed in the end portion of the first nozzle array L1 and the first dot array D1 formed by the nozzle #2 disposed on the right side of the nozzle #1 disposed in the end portion, it is possible to determine that the head 31 is not inclined too much. When the reference second dot array SD2 is not formed between the reference first dot array SD1 and the first dot array D1 formed by the nozzle #2, it is determined that the head 31 is inclined too much.

In this way, the head 31 is determined whether or not to be inclined too much. When the head 31 is not inclined too much (S002 →NO), as shown in FIG. 5, a small slope of the head 31 is detected (S004). On the other hand, when head 31 is inclined too much, the large slope of the head 31 is adjusted, and the head 31 is caused to form the test pattern again. In addition, when the large slope of the head 31 is adjusted, in the case where the reference second dot array SD2 is shifted away to the right side in the paper width direction (see FIG. 9), the slope of the head 31 is adjusted in the counterclockwise direction. Further, in the case where the reference second dot array SD2 is shifted away on the left side in the paper width direction, the slope of the head 31 is adjusted in the clockwise direction. In this way, it is confirmed that the head 31 is not inclined too much on the basis of the dot arrays SD1 and SD2 as reference, and then the small slope of the head 31 is detected on the basis of the positional relationship between the first dot array D1 and the second dot array D2. By this, the slope of the head 31 can be detected with high accuracy.

Here, it is assumed that the length of the reference first dot array SD1 and the reference second dot array SD2 which are formed by the nozzles #1 and #180 disposed in the end portions of the first nozzle array L1 and the second nozzle array L2 is similar to the length of the dot arrays formed by the other nozzles. For convenience of explanation in FIG. 9, the first pattern P1 is illustrated by reducing the number of the nozzles, and is drawn larger than the actual first pattern P1. For this reason, even though the reference first dot array SD1 and the reference second dot array SD2 have the same length as that of the other dot arrays, it is possible to determine that the first dot array D1 and the second dot array D2 to be originally formed adjacent to each other are formed in positions separated away from each other.

However, the actual test pattern is smaller than the test pattern shown in FIG. 9, and also the interval between the first dot array D1 and the second dot array D2 becomes minute. In addition, in the actual test pattern, the number of the dot arrays increases. Therefore, when the reference first dot array SD1 and the reference second dot array SD2 have the same length as that of the other dot arrays, it is difficult to determine whether or not the first dot array D1 and the second dot array D2 to be originally formed adjacent to each other are formed adjacent to each other. That is, it is difficult to determine whether or not the head 31 is inclined too much. As a result, there is some fear that the slope of the head 31 is detected on the basis of the positional relationship between two first dot arrays D1 adjacent to each other in the paper width direction and the second dot array D2 different from the second dot array D2 to be originally formed between the first dot arrays.

In this embodiment, the length of the dot arrays formed by the nozzles (#1 and #180) disposed in the end portions of the first nozzle array L1 and the second nozzle array L2 is formed longer than that of the dot arrays formed by the other nozzles. By this, the first dot array D1 and the second dot array D2 to be formed adjacent to each other in the paper width direction, that is, the reference first dot array SD1 and the reference second dot array SD2 can be correctly detected even in the test patterns P1 and P2 which include many dot arrays aligned in the paper width direction. Then, it is possible to accurately detect that the head 31 is inclined too much according to whether or not the reference first dot array SD1 and the reference second dot array SD2 are adjacent to each other (by referring to test pattern shown in FIGS. 6A to 6C, according to whether or not the right dot array of the reference first dot array SD1 is the reference second dot array SD2).

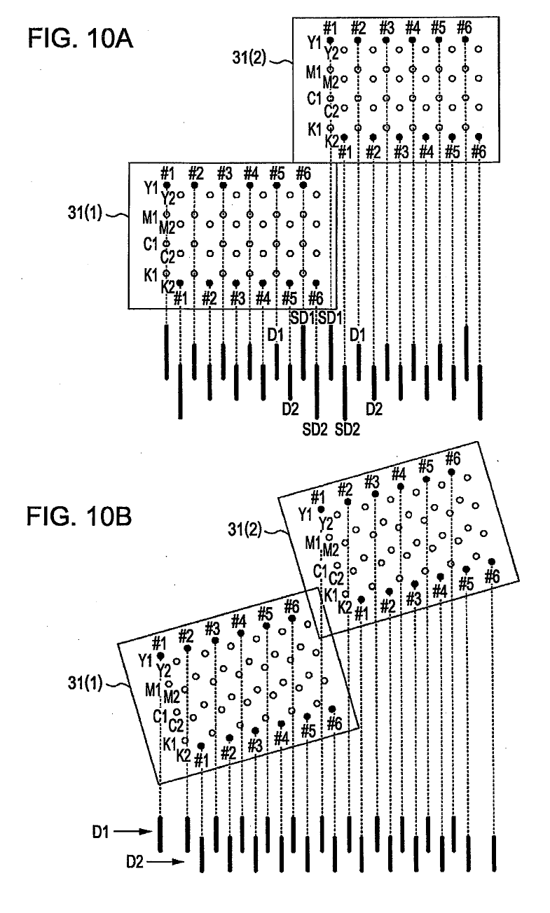

FIG. 10A is a view illustrating the first pattern P1 according to this embodiment in which two heads 31(1) and 31(2) are formed in parallel to the paper width direction. FIG. 10B is a view illustrating the test pattern as a comparative example in which two heads 31(1) and 31(2) are obliquely formed in the counterclockwise direction to the paper width direction. In the test pattern of the comparative example shown in FIG. 10B, it is assumed that all of the dot arrays have the same length.

In the printer 1 according to this embodiment, plural heads 31 are aligned in the paper width direction as shown in FIG. 3A. For this reason, the test pattern for adjusting the slope of the head 31 is formed such that the first pattern P1 and the second pattern P2 formed by the plural heads 31 are aligned in the paper width direction as shown in FIG. 6A. That is, the dot arrays formed by the heads 31 different from each other are aligned in the paper width direction.

In FIG. 10A, since two heads 31(1) and 31(2) are disposed in parallel to the paper width direction without inclination, the interval between the first dot array D1 formed by the first nozzle array (yellow nozzle array Y1) and the second dot array D2 formed by the second nozzle array (black nozzle array K2) is uniform (360 dpi) in the paper width direction. In addition, as shown in FIG. 3B, since the interval between the nozzles disposed in the end portions in the heads 31 adjacent to each other in the paper width direction is 360 dpi, the interval between the first dot array D1 and the second dot array D2 which are formed by the nozzles corresponding to a joint portion between the heads 31(1) and 31(2) is also uniform (360 dpi).

On the other hand, even though two heads 31 shown in FIG. 10B are inclined with respect to the paper width direction, the interval between the first dot array D1 and the second dot array D2 in the paper width direction is uniform. This is because that the heads 31 is inclined in the counterclockwise direction and the second dot array D2 is formed in a position separated away from the first dot array D1 to be formed adjacent to each other. As a result, the interval between the first dot array D1 and the second dot array D2 which are not originally adjacent to each other in the paper width direction becomes uniform.

In addition, when the head 31(1) and the head 31(2) which are adjacent to each other in the paper width direction are inclined in the same direction to the same degree, the second dot array D2 is formed by the nozzle #6 disposed in the right end portion of the black nozzle array K2 in the left head 31(1) between the first dot arrays D1 formed by the nozzles #1 and #2 disposed in the left end portion of the yellow nozzle array Y1 in the right head 31(2). In this reason, the interval between the first dot array D1 and the second dot array D2 formed in a joint portion between the heads 31(1) and 31(2) becomes also uniform (360 dpi).

That is, in this embodiment, as shown in FIG. 6A, since the patterns P1 and P2 formed by the heads 31 are aligned in the paper width direction, when all of the dot arrays D1 and D2 are formed with the same length in the test pattern, it is particularly difficult to determine whether or not the first dot array D1 and the second dot array D2 to be originally formed adjacent to each other are adjacent.

In addition, when all of the dot arrays D1 and D2 are formed with the same length in the test pattern, it is difficult to specify which dot arrays D1 and D2 are formed by which heads 31. For this reason, on the basis of the positional relationship between the first dot array D1 and the second dot array D2 formed by a head 31 different from one head 31, the slope of the one head 31 may be detected.

Therefore, the dot arrays SD1 and SD2 formed by the nozzles #1 and #180 disposed in the end portions of the first nozzle array L1 and the second nozzle array L2 are formed longer than the dot arrays formed by the other nozzles. That is, the dot arrays formed by the nozzles (the nozzles #6 in FIG. 10A) disposed close to the end portions of the other head 31(2) among the nozzles belonging to the first nozzle array L1 and the second nozzle array L2 in one head 31(1) among two heads 31(1) and 31(2) aligned in the paper width direction are formed to be different in length from the length of the dot arrays formed by the other nozzles. By this, among a number of the dot arrays aligned in the paper width direction, it is possible to find out the reference first dot array SD1 and the reference second dot array SD2 adjacent to each other in the paper width direction. As a result, the large slope of the head 31 can be detected on the basis of whether or not the reference first dot array SD1 and the reference second dot array SD2 to be originally formed adjacent to each other in the paper width direction are adjacent. In addition, it is not limited to that the reference first dot array SD1 and the reference second dot array SD2 are longer than the other dot arrays D1 and D2, but it may be formed to be short. However, when the reference first dot array SD1 and the reference second dot array SD2 are longer than the dot arrays formed by the other nozzles, it is easy to find the reference first dot array SD1 and the reference second dot array SD2 out of the test pattern.

As shown in FIG. 10A, when the patterns P1 and P2 formed by the plural heads 31 are aligned in the paper width direction, the large slope of the head 31 can be detected according to whether or not the reference second dot array SD2 formed by the nozzle #6 disposed in the end portion of the second nozzle array L2 in the left head 31(1) is positioned between the reference first dot array SD1 formed by the nozzle #6 disposed in the end portion of the first nozzle array L1 in the left head 31(1) and the reference first dot array SD1 formed by the nozzle #1 disposed in the end portion of the first nozzle array L1 in the right head 31(2). For this reason, the dot array formed by the nozzle #1 disposed in the left end portion of the second nozzle array L2 in the right head 31(2) may not be longer than the other dot arrays. However, it is necessary for the dot array formed by the nozzle #6 disposed in the right end portion of the second nozzle array L2 in the right head 31(2) to be longer than the other dot arrays.

In addition, the dot arrays SD1 and SD2 formed by the nozzles (#1 and #180) disposed in the end portions of the first nozzle array L1 and the second nozzle array L2 are not limited to be longer than the other dot arrays. For example, the dot arrays formed by a nozzle #i in the first nozzle array L1 and the nozzle #i-1 (or nozzle #i) in the second nozzle array disposed in a position closest to the nozzle #i in the paper width direction may be different from the other dot arrays in length. By this, the large slope of the head 31 can be correctly detected.

However, when the dot arrays SD1 and SD2 formed by the nozzles (#1 and #180) disposed in the end portions of the first nozzle array L1 and the second nozzle array L2 are formed to be longer than the other dot arrays, it is easy to specify the patterns P1 and P2 formed by the heads 31(1) to 31(n). That is, in the test patterns, it is easy to specify the dot arrays formed in the joint portions between the heads 31. By this, on the basis of the positional relationship between the first dot array D1 and the second dot array D2 formed by a head 31 different from one head 31, it is possible to prevent that the slope of the different head 31 can be detected. Accordingly, the slope of each head 31 can be detected with high accuracy.

### Small Slope Detection of Head 31

As shown in the slope adjustment flow of the head 31 shown in FIG. 5, when it is determined that the head 31 is not inclined too much (S002→No), the small slope of the next head 31 is detected (S004). The small slope of the head 31 is determined on the basis of the positional relationship between the first dot array D1 and the second dot array D2 in the paper width direction as described above (see FIGS. 7A to 7C). First, it is determined whether or not the second dot array D2 is formed in the center portion between two first dot arrays D1 aligned in the paper width direction. That is, it is confirmed whether or not the interval between the first dot array D1 and the second dot array D2 in the paper width direction is the nozzle interval of “360 dpi” between the first nozzle array L1 and the second nozzle array L2. As shown in FIG. 7A, when the second dot array D2 is formed in the center portion between two first dot arrays D1, it is possible to determine that the head 31 is not inclined with respect to the paper width direction. In this case, it is not necessary to adjust the slope of the head 31.

As shown in FIG. 7B, when the second dot array D2 is formed close to the first dot array D1 disposed on the right side among two first dot arrays D1 aligned in the paper width direction, it is possible to determine that the head 31 is inclined in the counterclockwise direction. On the contrary, as shown in FIG. 7C, when the second dot array D2 is formed close to the first dot array D1 disposed on the left side among two first dot arrays D1 aligned in the paper width direction, it is possible to determine that the head 31 is inclined in the clockwise direction.

In addition, it is possible to detect the inclination amount of the head 31 according to how much the second dot array D2 is shifted from the center portion between two first dot arrays D1. As the misalignment amount of the second dot array D2 shifted from the center portion between two first dot arrays D1 decreases, the inclination amount of the head 31 decreases. Further, as the misalignment amount of the second dot array D2 shifted from the center portion between two first dot arrays D1 increases, the inclination amount of the head 31 increases. In addition, the inclination amount of the head 31 with respect to the misalignment amount of the second dot array shifted from the center portion between two first dot arrays D1 may be calculated in advance.

On the basis of the inclined direction and the inclination amount with respect to the paper width direction of each head 31 detected in this way, the slope of each head 31 is adjusted. Here, the mounted position of the head 31 (nozzle array) on the printer 1 is adjusted such that the paper width direction cross to the moving direction specified by the transport unit 20 is parallel to the nozzle array. By this, each head 31 (nozzle array) is aligned in parallel to the paper width direction. As a result, the dot arrays aligned in the paper width direction at a predetermined interval can be formed, and it is possible to suppress the degradation of the image quality.

In this embodiment, the slope of the head 31 is detected on the basis of the positional relationship between the first dot array D1 and the second dot array D2 in the paper width direction. As a kind of a paper for forming the test pattern, there may be used a paper capable of adsorbing the ink very well (for example, a plain paper). For this reason, when the interval between the first dot array D1 and the second dot array D2 is narrowed (360 dpi) as in the case of the first pattern P1, there is some fear that it is impossible to determine whether or not the second dot array D2 is formed in the center portion between two first dot arrays D1. Thus, the second pattern P2 is formed such that the interval between the first dot array D1 and the second dot array D2 is wider than that of the first pattern P1. By this, the slope of the head 31 can be detected regardless of the kind of the paper for forming the test pattern.

In addition, in the result of the test patterns P1 and P2, the positional relationship between the first dot array D1 and the second dot array D2 in the paper width direction and the interval between the first dot array D1 and the second dot array D2 in the paper width direction may be measured by the naked eye, or may be read out by a scanner. For example, when the scanner is used to read out, the positions of the dot arrays D1 and D2 in the paper width direction are specified on image data to be read out, and then the interval between the first dot array D1 and the second dot array D2 may be calculated. In addition, since the interval between the first dot array D1 and the second dot array D2 is minute, the places where the interval between the first dot array D1 and the second dot array D2 is narrow is made to be darkly identified, and the places where the interval between the first dot array D1 and the second dot array D2 is wide is made to be lightly identified, for example. Then, the slope of the head 31 may be detected by the position of test patterns P1 and P2 printed in contrasting density.

### Separation Adjustment of Plural Heads 31 in Paper Width Direction

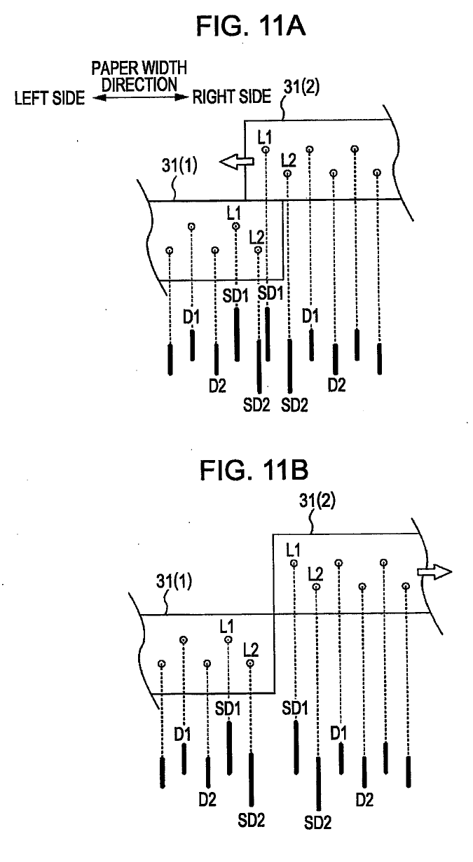

FIGS. 11A and 11B are views illustrating adjustment for the positional relationship between the plural heads 31 aligned in the paper width direction. The slope of each head 31 is adjusted with respect to the paper width direction, and then the heads 31 are caused to print the test patterns (see FIGS. 6A to 6C) again, so that the positional relationship between the plural heads 31 in the paper width direction may be adjusted.

For example, on the basis of the position of the leftmost head 31(1) among the plural heads 31(1) to 31(n) aligned in the paper width direction, the positions of the heads 31(2) to 31(n) disposed on the right side therefrom in the paper width direction is determined in this order. AS shown in FIG. 11A, when the reference second dot array SD2 formed by the nozzle disposed in the end portion of the second nozzle array L2 in the head 31(1) is formed close to the reference first dot array SD1 formed by the nozzle disposed in the end portion of the first nozzle array L1 in the head 31(2), it can be known that the head 31(2) is mounted close to the head 31(1) as reference to the left side thereof. On the contrary, as shown in FIG. 11B, when the reference second dot array SD2 in the head 31(1) is formed close to the reference first dot array SD1 in the same head 31(1), it can be known that the head 31(2) is mounted separate from the head 31(1) as reference to the right side thereof.

In this way, the position on which the head 31 is mounted in the paper width direction can be also adjusted on the basis of the test pattern having the same shape as the test pattern for detecting the slope of the head 31. As a result, it is possible to form the dot arrays disposed along the length in the paper width direction at equal intervals (360 dpi). Further, it is possible to suppress the degradation of the image quality.

In addition, on the basis of the test patterns P1 and P2, even when the interval between the heads 31 in the paper width direction is detected, the dot arrays SD1 and SD2 formed by the nozzles #1 and #180 disposed in the end portions of the first nozzle array L1 and the second nozzle array L2 are formed longer than the dot arrays D1 and D2 formed by the other nozzles. By this, the joint position between the heads 31 can be specified without an error. Further, the intervals between the heads 31 in the paper width direction can be adjusted with high accuracy.

### Modified Example of Test Pattern

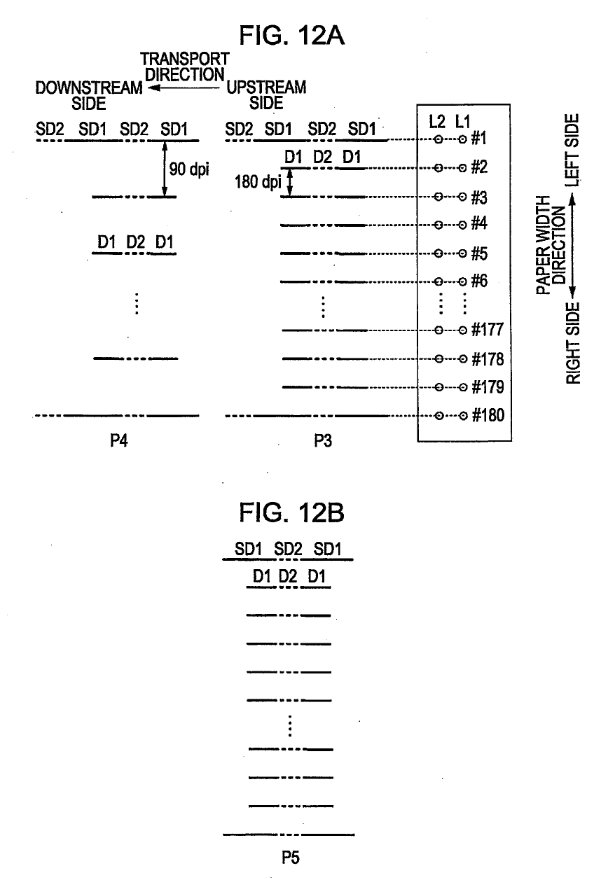

FIG. 12A is a view illustrating test patterns P3 and P4 according to a modified example. In the above-mentioned test patterns P1 and P2 (see FIGS. 6A to 6C), the test patterns P1 and P2 are formed by using two nozzle arrays (for example, Y1 and K2) which are shifted in the paper width direction. On the other hand, the test patterns P3 and P4 according to the modified example are formed by using two nozzle arrays L1 and L2 disposed at equal intervals in the paper width direction. For example, as shown in FIG. 3B, the yellow nozzle array Y1 is selected as the first nozzle array L1, the black nozzle array K1 is selected as the second nozzle array L2, and thus the test patterns according to the modified example are formed.

In the test patterns P3 and P4 according to the modified example, the second dot arrays D2 formed by the nozzles of the second nozzle array L2 is positioned between the first dot arrays D1 formed by the nozzles of the first nozzle array L1. For convenience of explanation, the first dot arrays D1 formed by the first nozzle array L1 are shown with a solid line, and the second dot arrays D2 formed by the second nozzle array L2 are shown with a dotted line. Therefore, the interval between the dot arrays D1 and D2 aligned in the paper width direction becomes the interval of “180 dpi”. Further, in consideration of the test pattern being printed on the wettable paper S, as the test pattern P4, the dot arrays may be formed by every other nozzle. In such a test pattern P4, the interval between the dot arrays in the paper width direction becomes the interval of “90 dpi”.

Also in the test patterns P3 and P4 according to the modified example, the dot arrays formed by the nozzles #1 and #180 disposed in the end portions of two nozzle arrays L1 and L2 are formed longer than the dot arrays formed by the other nozzles. For this reason, the reference first dot array SD1 formed by the nozzle disposed in the end portion of the first nozzle array L1 is formed longer than the first dot array D1 formed by the other nozzles. Then, each nozzle other than the nozzles disposed in the end portion of the second nozzle array L2 forms one second dot array D2. The nozzles #1 and #180 disposed in the end portions of the second nozzle array L2 form two reference second dot arrays SD2.

In addition, when the head 31 is excessively inclined, the first dot array D1 and the second dot array D2 to be aligned in the paper width direction are formed on positions shifted away from each other. Further, there is some fear that the slope of the head 31 is detected on the basis of the positional relationship between the first dot array D1 and the second dot array D2 formed by the nozzles (for example, the nozzle #1 and the nozzle #2) which are formed on different positions in the paper width direction. For this reason, it is determined whether or not two reference first dot arrays SD1 and two reference second dot arrays SD2 are formed on positions shifted away from each other, and then it is confirmed that the head 31 is not inclined too much. By this, the slope of the head 31 can be detected with high accuracy.

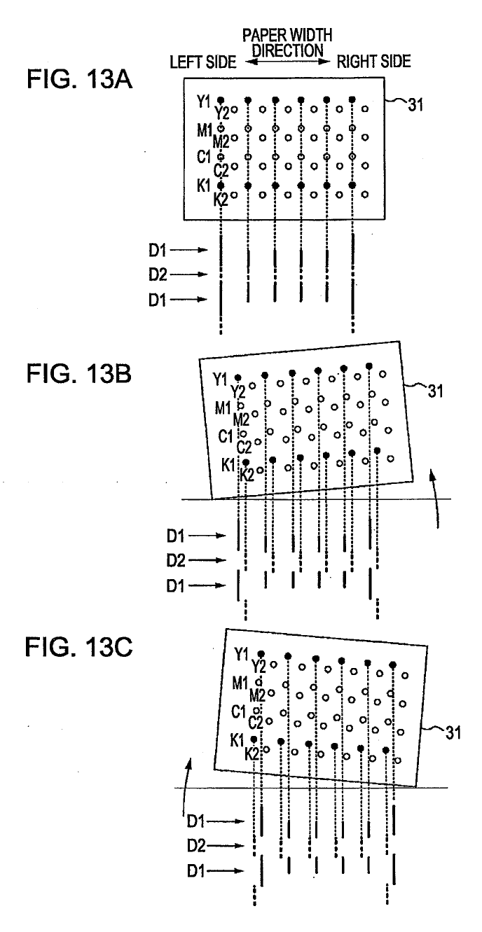

FIG. 13A is a view illustrating the test pattern P3 formed by the head 31 mounted in parallel to the paper width direction. FIG. 13B is a view illustrating the test pattern formed by the head 31 inclined in the counterclockwise direction to the paper width direction. FIG. 13C is a view illustrating the test pattern formed by the head 31 inclined in the clockwise direction to the paper width direction. As shown in FIG. 13A, when the first dot array D1 and the second dot array D2 are not shifted in the paper width direction and are straight aligned in the transport direction, it can be determined that the head 31 is mounted in parallel to the paper width direction. On the other hand, as shown in FIG. 13B, when the first dot array D1 is formed in a position shifted from the second dot array D2 on the left side in the paper width direction, it can be determined that the head 31 is inclined in the counterclockwise direction to the paper width direction. On the contrary, as shown in FIG. 13C, when the first dot array D1 is formed in a position shifted from the second dot array D2 on the right side in the paper width direction, it can be determined that the head 31 is inclined in the clockwise direction to the paper width direction.

In the test patterns P3 and P4 according to the modified example, the interval between the dot arrays are wider than that in the test patterns P1 and P2 described above, and it is easy to detect the direction or the misalignment amount by which the first dot array D1 is shifted from the second dot array D2. On the contrary, in the test patterns P1 and P2 described above, the interval between the dot arrays is narrower than that in the test patterns P3 and P4 in the modified example, and it is possible to detect the slope of the head 31 with high accuracy. For this reason, when the test patterns are formed, the test patterns P1 and P2 described above and the test patterns P3 and P4 in the modified example may be formed all together.

FIG. 12B is a view illustrating a test pattern P5 according to another modified example. According to such a test pattern P5, similar to FIGS. 13A to 13C, the slope of the head 31 can be adjusted by shifting the first dot array D1 with respect to the second dot array D2. In this case, in the test pattern P5, the reference first dot arrays SD1 formed by the nozzles #1 and #180 disposed in the end portions of the first nozzle array L1 is formed longer than the first dot arrays D1 formed by the other nozzles. Further, the nozzles #1 and #180 disposed in the end portions of the second nozzle array L2 are caused to form one reference second dot array SD2. For this reason, in the test pattern P5, when the large slope of the head 31 is detected, the length of the reference second dot array SD2 which is aligned with the reference first dot arrays SD1 in the transport direction is equal to the length of the second dot arrays D2 formed by the other nozzles. Therefore, there is some fear that the large slope of the head 31 is erroneously detected. Then, it may be formed by combining the test pattern P5 in the modified example and the test patterns P1 and P2 describe above. By this, the large slope of the head 31 can be detected on the basis of the above-mentioned test patterns P1 and P2.

### Usage Example of Test Pattern

In the manufacturing processes described above, the embodiments has been shown in which the test patterns shown in FIGS. 6A to 6C are formed by the plural heads 31 included in the printer 1, and the slope of each head 31 is adjusted, and then the interval between the heads 31 which are adjacent to each other in the paper width direction as shown in FIG. 11 is adjusted. However, the invention is not limited thereto, but for example, even when a head 31 in the printer 1 used by the user is out of order and thus is replaced with a new head 31, the test patterns shown in FIGS. 6A to 6C may be formed. If so, it is possible to confirm that the replaced head 31 is mounted in parallel to each other in the paper width direction without inclination. When only the slope of the head 31 is adjusted, the test patterns may be formed only by the replaced head 31. However, when the positional relationship between the replaced head 31 and the head 31 mounted already in the paper width direction is adjusted, it is necessary to form the test patterns by at least the replaced head 31 and the head 31 adjacent thereto in the paper width direction.

In addition, in a state where the slope of each head 31 with respect to the paper width direction or the misalignment between the heads 31 in the paper width direction is adjusted, the plural heads 31 are disposed on the nozzle plate. Even when the nozzle plate is mounted on the printer 1, the test patterns (see FIGS. 6A to 6C) can be used. The nozzle plate can be mounted on the printer 1 such that the nozzle array direction of the heads 31 disposed on the nozzle plate is parallel to the paper width direction on the basis of the result of the test patterns.

In addition, as described above, the slope of the head 31 with respect to the paper width direction or the misalignment in the paper width direction is corrected by adjusting the head 31 (or the nozzle plate), but the invention is not limited thereto. For example, the slope of the transport unit 20 or the position thereof in the paper width direction with respect to the head 31 may be adjusted.

### Second Embodiment

### Nozzle Alignment

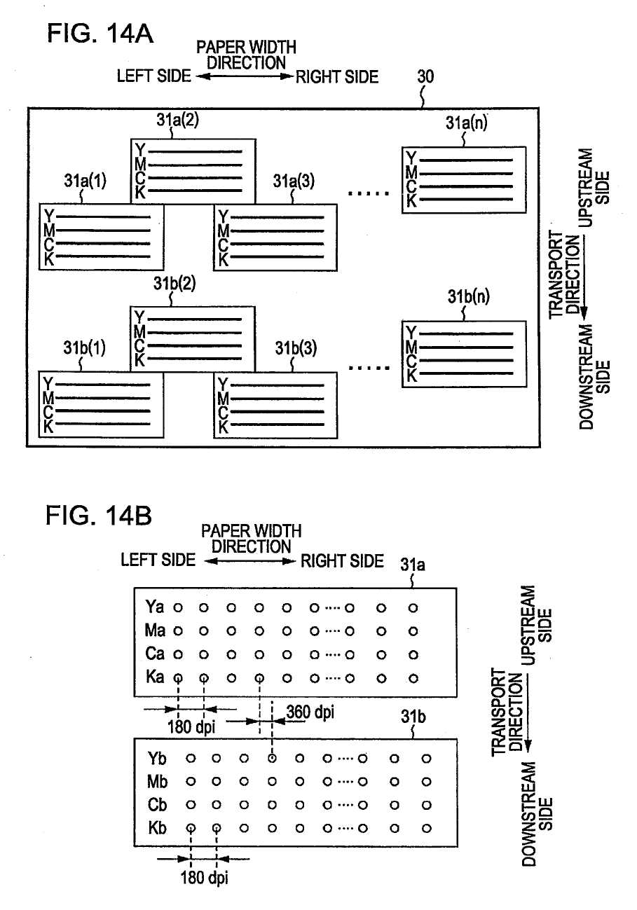

FIG. 14A is a view illustrating the heads 31 aligned on the bottom surface of the head unit 30 according to a second embodiment. FIG. 14B is a view illustrating the nozzles aligned on the bottom surface of the head 31. In the second embodiment, two head groups with the heads 31 aligned in a stagger shape in the paper width direction are included in the head unit 30. Here, the heads 31 belonging to the upstream head group in the transport direction is called as “upstream heads 31a”, an the heads 31 belonging to the downstream head group in the transport direction is called as “downstream heads 31b”.

As shown in FIG. 14B, the heads 31a and 31b each includes the yellow nozzle array Y, the magenta nozzle array M, a cyan nozzle array C, and the black nozzle array K. In each nozzle array, the nozzles are configured to be aligned in the paper width direction with the interval of 180 dpi therebetween, the interval between the nozzles disposed in the end portions of the heads 31 adjacent to each other is also to be 180 dpi. Then, the nozzle array of the upstream head 31a corresponding to the nozzle array of the downstream head 31b is disposed in a position shifted by the interval of “360 dpi” on the left side in the paper width direction. That is, the nozzles ejecting the four colors of ink Y, M, C, and K are aligned over the length in the paper width direction with the interval of 360 dpi therebetween.

Misalignment between Upstream Head 31a and Downstream Head 31b

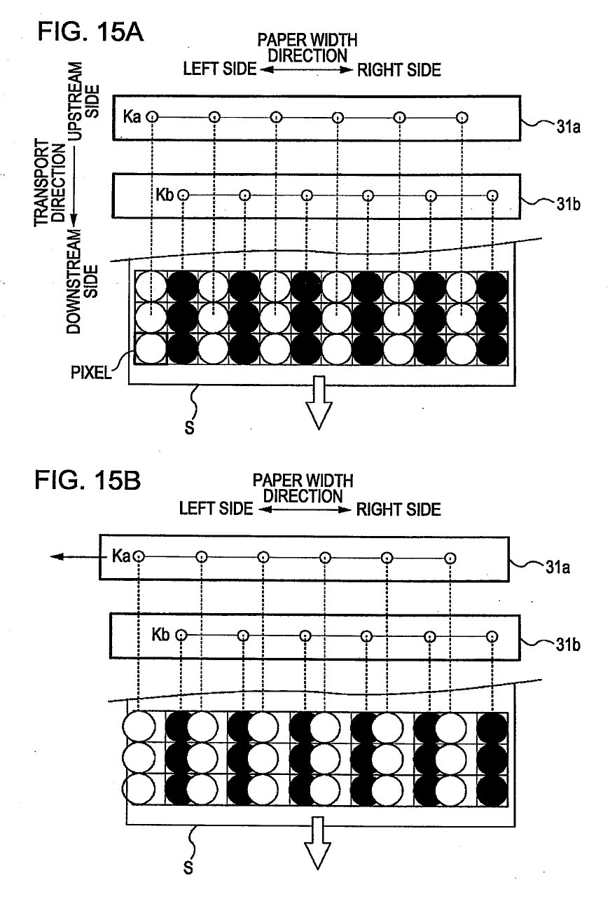

FIG. 15A is a view illustrating the dots formed in a case where the positional relationship between the upstream head 31a and the downstream head 31b in the paper width direction is correct. FIG. 15B is a view illustrating the dots formed in a case where the upstream head 31a is shifted on the left side in the paper width direction with respect to the downstream head 31b. For convenience of explanation, the dots formed by the upstream head 31a is shown with “o”, and the dots formed by the downstream head 31b is shown with “•”. As shown in FIG. 15A, the nozzle array of the upstream head 31a corresponding to the nozzle array of the downstream head 31b is disposed in a position shifted on the left side in the paper width direction with the interval of 360 dpi therebetween as it was designed. For this reason, the dot arrays aligned in the paper width direction are formed with the interval of 360 dpi therebetween.

On the other hand, as shown in FIG. 15B, when the upstream head 31a is shifted and mounted on the left side in the paper width direction with respect to the downstream head 31b, the dots formed by the upstream head 31a are formed on positions shifted on the left side in the paper width direction from the pixel positions instructed by the print data. Then, the intervals between the dots aligned in the paper width direction do not become constant. In this way, when the positional relationship between the upstream head 31a and the downstream head 31b in the paper width direction is shifted, the intervals between the dots in the dot arrays aligned in the paper width direction do not become constant, and this shows up lines displayed on the print image.

An object in the second embodiment is to adjust the misalignment in the paper width direction between two heads of the upstream head 31a and the downstream head 31b aligned in the transport direction, and to suppress the image degradation. In addition, in FIG. 15B, the upstream head 31a is shifted on the left side with respect to the downstream head 31b, but the invention is not limited thereto. The upstream head 31a may be shifted to the right side, or the downstream head 31b may be shifted, or the both of the upstream head 31a and the downstream head 31b may be shifted from each other.

Misalignment Adjustment between Upstream Head 31a and Downstream Head 31b in Paper Width Direction

Also in the second embodiment, the first nozzle array L1 is selected among the nozzle arrays included in the upstream head 31a, the second nozzle array L2 is selected among the nozzle arrays included in the downstream head 31b, and then the test patterns having the same shape as the test patterns (see FIGS. 6A to 6C, and FIG. 12) shown in the above-mentioned embodiments are formed. Hereinafter, a case where the first pattern P1 shown in FIG. 6B is formed by using two nozzle arrays L1 and L2 which are shifted at the interval of 360 dpi in the paper width direction will be shown by way of example. The black nozzle array Ka in the downstream head 31b is selected as the first nozzle array L1, and the black nozzle array Kb in the downstream head 31b is selected as the second nozzle array L2. In addition, in the first embodiment, the nozzle arrays (for example, Y1 and K2) separated in the transport direction as much as it can be is selected in order to adjust the slope of the head 31. However, in the second embodiment, it may not be necessarily to select the nozzle arrays separate in the paper width direction in order to adjust the misalignment in the paper width direction.

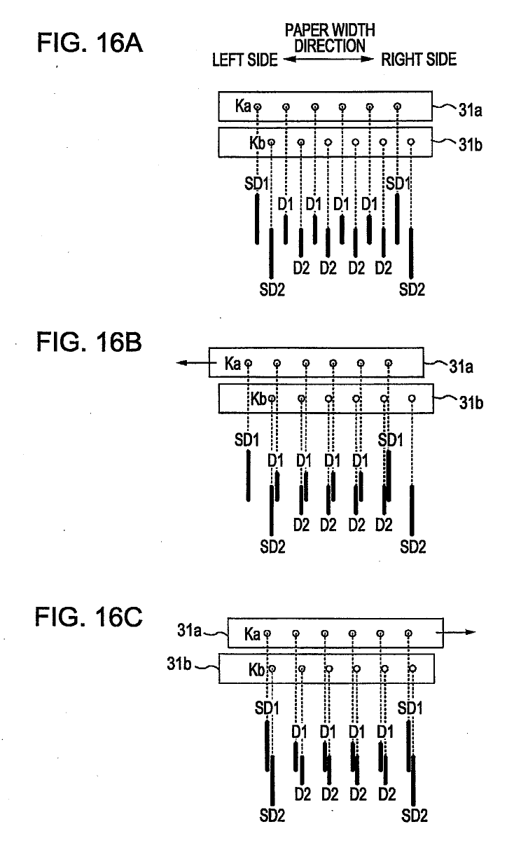

FIG. 16A is a view illustrating the first pattern P1 formed in a case where the positional relationship between the upstream head 31a and the downstream head 31b in the paper width direction is correct. FIG. 16B is a view illustrating the first pattern P1 formed in a case where the upstream head 31a is shifted on the left side in the paper width direction with respect to the downstream head 31b. FIG. 16C is a view illustrating the first pattern P1 formed in a case where the upstream head 31a is shifted to the right side in the paper width direction with respect to the downstream head 31b.

As shown in FIG. 16A, when the second dot array D2 is formed in the center portion between two first dot arrays D1 aligned in the paper width direction, it is possible to determine that the positional relationship between the upstream head 31a and the downstream head 31b in the paper width direction is not shifted. On the other hand, as shown in FIG. 16B, when the second dot array D2 disposed between two first dot arrays D1 aligned in the paper width direction is formed close to the first dot array D1 disposed on the right side thereof, it is possible to determine that the upstream head 31a is shifted on the left side with respect to the downstream head 31b (or the downstream head 31b is shifted to the right side with respect to the upstream head 31a). On the contrary, as shown in FIG. 16C, when the second dot array D2 disposed between two first dot arrays D1 aligned in the paper width direction is formed close to the first dot array D1 disposed on the left side, it is possible to determine that the upstream head 31a is shifted to the right side with respect to the downstream head 31b (or the downstream head 31b is shifted to the left side with respect to the upstream head 31a).

In this way, the positional relationship between the upstream head 31a and the downstream head 31b in the paper width direction can be determined on the basis of the result of the test pattern. In addition, the positions of the upstream head 31a and the downstream head 31b aligned in the transport direction are adjusted in the paper width direction, and the upstream head 31a and the downstream head 31b may be aligned in the paper width direction. Further, the heads 31 are aligned in the paper width direction to form an upstream head group and a downstream head group, and then the positions of the upstream head group and the downstream head group in the paper width direction may be adjusted.

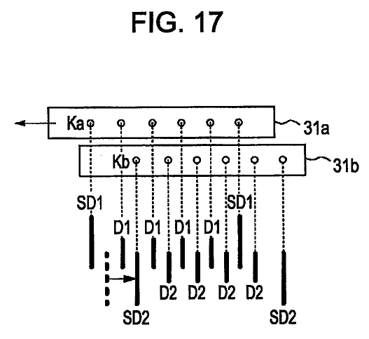

FIG. 17 is a view illustrating the first pattern P1 formed in a case where the positional misalignment amount of the upstream head 31a with respect to the downstream head 31b is large. When the misalignment amount between the upstream head 31a and the downstream head 31b in the paper width direction is large, the second dot array D2 different from the second dot array D2 to be originally formed is formed between two first dot arrays D1. Similarly to the above-mentioned first embodiment, the large misalignment of the head 31 may be detected on the basis of the reference first dot array SD1 and the reference second dot array SD2 which are different from the other dot arrays in length.

When the length of the dot arrays constituting the test pattern is formed all the same, it is difficult to determine whether or not the first dot array D1 and the second dot array D2 to be adjacent to each other in the paper width direction are adjacent. In particular, as in the printer 1 of this embodiment, when the test pattern is formed by the plural heads 31 aligned in the paper width direction at the same time, it is very difficult to determine whether or not the dot arrays D1 and D2 formed by different heads 31 are aligned in the paper width direction and the first dot array D1 and the second dot array D2 to be aligned in the paper width direction are adjacent. Then, the dot arrays SD1 and SD2 formed by the nozzles disposed in the end portions of the first nozzle array L1 and the second nozzle array L2 are formed longer than the other dot arrays, and thus it becomes easy to find out the reference first dot array SD1 and the reference second dot array SD2 from the result of the test pattern.

In the result of the first pattern P1, when the dot array formed on the right side of the reference first dot array SD1 is the reference second dot array SD2, it is possible to determine that the head 31 is not shifted too much. When the head 31 is not shifted too much, the small misalignment amount or direction of the head 31 in the paper width direction is detected on the basis of the positional relationship between the first dot array D1 and the second dot array D2 of the first pattern P1. On the other hand, when the head 31 is shifted too much, the large misalignment is adjusted, and then the misalignment of the head 31 may be detected on the basis of the result of the test pattern formed again. By this, the misalignment between the upstream head 31a and the downstream head 31b in the paper width direction can be detected with high accuracy.

In addition, when the test pattern is formed by using the plural upstream heads 31a and the downstream heads 31b aligned in the paper width direction, as shown in FIG. 6A, a number of patterns are aligned in the paper width direction. For this reason, the dot arrays SD1 and SD2 formed by the nozzles disposed in the end portions of the nozzle arrays in the upstream heads 31a and the downstream heads 31b are formed longer than the nozzle arrays D1 and D2 formed by the other nozzles, and thus it becomes easy to specify the joint portion between the heads 31. As a result, the misalignment between the upstream heads 31a and the downstream heads 31b in the paper width direction can be detected with high accuracy on the basis of the positional relationship between the first dot arrays D1 and the second dot arrays D2 formed by the upstream heads 31a and the downstream heads 31b .

### Other Embodiments

In the above-mentioned embodiments, the print system having the ink jet printer has been described mainly. However, the disclosures of the adjustment method of the slope of the head and the like are included. In addition, the above-mentioned embodiments are described for the purpose of easily understanding the invention, and nothing described above should be interpreted as limiting the scope of the invention. The invention can be made various changes and improvements without departing the main points. It is matter of course that the invention includes the equivalences. In particular, even the embodiments described below are included in the invention.

### Printing Apparatus

In the above-mentioned embodiments, the piezoelectric scheme has been employed in which a voltage is applied on the driving element (piezoelectric element) to expend and shrink the ink chamber and thus the liquid therein is ejected. The thermal scheme may also be employed in which bubbles are generated in the nozzle by using a heating element and the liquid is ejected by the bubbles.

### Serial Type Printer

In the above-mentioned embodiments, the line head printer in which the heads are aligned in the paper width direction cross to the transport direction of the medium has been described as an example, but the invention is not limited thereto. For example, the serial type printer which alternatively performs the image forming operation for forming the images while moving the heads in the moving direction cross to the transport direction of the medium and the transport operation for transporting the medium may also detect the slope and the misalignment of the heads on the basis of the above-mentioned test patterns. In addition, there is a printer using the plural heads for printing at high speed among the serial type printers. In this type of printer, particularly, when the slope or the misalignment of the heads is detected, the dot array formed by a specific nozzle is formed to be longer than the dot arrays formed by the other nozzles. Therefore, in the case where the heads are inclined too much or shifted, it is easy to determine that the dot arrays in the test pattern are formed separate away from each other.

What is claimed is:

1. A printing apparatus comprising:
a first nozzle array with nozzles aligned in a predetermined direction for ejecting liquid on a medium;
a second nozzle array with nozzles aligned in the predetermined direction for ejecting liquid on the medium, the second nozzle array being aligned in a direction cross to the predetermined direction of the first nozzle array; and
a moving mechanism for relatively moving the first nozzle array, the second nozzle array, and the medium in the moving direction,
wherein when a plurality of dot arrays disposed along the moving direction is formed in a direction cross to the moving direction with a predetermined interval therebetween by using the nozzles belonging to the first nozzle array, and a plurality of dot arrays disposed along the moving direction is formed in a direction cross to the moving direction with a predetermined interval therebetween by using the nozzles belonging to the second nozzle array,
the dot arrays are formed by a specific first nozzle among the nozzles belonging to the first nozzle array and a specific second nozzle among the nozzles belonging to the second nozzle array, and have a length different from the dot arrays formed by the other nozzles.

2. The printing apparatus according to claim 1, wherein the first nozzle is a nozzle closest to the second nozzle in the predetermined direction among the nozzles belonging to the first nozzle array.

3. The printing apparatus according to claim 1, wherein two heads including the first nozzle array and the second nozzle array are aligned in the predetermined direction,
wherein the first nozzle in one of the heads is a nozzle disposed close to an end portion of the other head among the nozzles belonging to the first nozzle array, and
wherein the second nozzle in one of the heads is a nozzle disposed close to an end portion of the other head among the nozzles belonging to the second nozzle array.

4. The printing apparatus according to claim 1, wherein when the plurality of dot arrays is formed in a direction cross to the moving direction with the predetermined interval therebetween,
another plurality of dot arrays disposed along the moving direction is formed in a direction cross to the moving direction with an interval wider than the predetermined interval therebetween by using the nozzles belonging to the first nozzle array, and another plurality of dot arrays disposed along the moving direction is formed in a direction cross to the moving direction with an interval wider than the predetermined interval therebetween by using the nozzles belonging to the second nozzle array.

5. A method of adjusting a nozzle array using a printing apparatus including a first nozzle array with nozzles aligned in a predetermined direction for ejecting liquid on a medium, a second nozzle array with nozzles aligned in the predetermined direction for ejecting liquid on the medium, the second nozzle array being aligned in a direction cross to the predetermined direction of the first nozzle array, and a moving mechanism for relatively moving the first nozzle array, the second nozzle array, and the medium in the moving direction, the method comprising:
when a plurality of dot arrays disposed along the moving direction is formed in a direction cross to the moving direction with a predetermined interval therebetween by using the nozzles belonging to the first nozzle array, and a plurality of dot arrays disposed along the moving direction is formed in a direction cross to the moving direction with a predetermined interval therebetween by using the nozzles belonging to the second nozzle array,
forming the dot arrays by a specific first nozzle among the nozzles belonging to the first nozzle array and a specific second nozzle among the nozzles belonging to the second nozzle array, the dot arrays having a length different from the dot arrays formed by the other nozzles; and
adjusting mounting positions of the first nozzle array and the second nozzle array in the print apparatus on the basis of a positional relationship between the dot arrays formed by the first nozzle array and the dot arrays formed by the second nozzle array in a direction cross to the moving direction.

6. The method according to claim 5, further comprising adjusting a positional relationship between the first nozzle array and the second nozzle array in a direction cross to the moving direction.

7. The method according to claim 5, further comprising adjusting slopes of the first nozzle array and the second nozzle array with respect to a direction cross to the moving direction.

8. The method according to claim 7, wherein the print apparatus includes another nozzle array between the first nozzle array and the second nozzle array, the another nozzle array including nozzles which eject the liquid on the medium and are aligned in the predetermined direction.
